(19) United States
(12) Patent Application Publication
(10) Pub. No.: US 2015/0065218 A1
(43) Pub. Date: Mar. 5, 2015

(54) System to Implement a Gaming Method with a Total Computed in Reverse Order

(71) Applicant: Franklin Daines, Red Deer (CA)

(72) Inventor: Franklin Daines, Red Deer (CA)

(21) Appl. No.: 14/017,141

(22) Filed: Sep. 3, 2013

Related U.S. Application Data
(60) Provisional application No. 61/873,264, filed on Sep. 3, 2013.

(51) Int. Cl. G07F 17/32

(52) U.S. Cl. CPC G07F 17/3267; G07F 17/3293; G07F 17/3244
USPC 463/12

(57) ABSTRACT

A method, apparatus, and computer readable storage to implement a wagering system such as blackjack. The system can be implemented using electronic hardware such as an electronic digital table, an internet casino, video gaming terminals/machines, and any other known electronic system. An algorithm is used by a processor such that upon a dealer bust, the cards in the dealer's hand are reversed and the dealer's total is recomputed using the same dealer's cards but in reverse order from the order originally dealt to the dealer. If the reverse dealer total is in a set of preset totals then instead of busting, the dealer is deemed to have made the reverse dealer total. This increases the house advantage and provides functionality for the game to offer an additional player advantage over the standard game, such as enabling the player to view the dealer's initial two cards before the player makes any decision as to how to play the player's hand.

### CROSS REFERENCE TO RELATED APPLICATIONS

This application claims benefit to U.S. provisional application 61/873,264, which is incorporated by reference herein in its entirety.

### BACKGROUND OF THE INVENTION

1. Field of the Invention

The present general inventive concept is directed to a method, apparatus, and computer readable storage medium directed to an improvement to a gaming system which can be implemented by an electronic system in a casino or using the internet.

2. Description of the Related Art

The casino game of blackjack is well known, for example see U.S. Patent publication 2003/0155715 which is incorporated by reference herein in its entirety.

FIG. 1 is a flowchart illustrating a method of implementing the known game of blackjack.

Points totals are computed by adding the standard rank value of each card (twos count as 2, threes count as 3, fours count as 4, fives count as 5, sixes count as 6, sevens count as 7, eights count as 8, nines count as 9), with face valued cards (tens, jacks, queens, kings) being given a value of 10, and aces being given a value of 1 or 11, whichever results in a better hand. A soft point total is where at least one ace is given the value of 11. A hard point total is a hand with all aces counting as 1.

In operation 100, the player makes a main wager by placing chips on a table. Then, in operation 102, the dealer deals two initial cards to each player (either face up or face down) and two initial cards to the dealer, typically one face down (“hole-card”), and one face up (the “up-card”). Then the player can decide whether to hit, stand, double, or split. If the player decides to hit, then the method proceeds to operation 106, which deals an additional card to a player. If a determination 108 determines that the player has busted (the player's hard point total is over 21), then the player loses the game and thus loses the main wager in operation 110, which ends the game. If the determination 108 determines that the player has not busted, then the method returns to operation 104, where the player can make another decision whether to hit or stand. In operation 104, the player can also double (not pictured) by place an additional wager of up to the main wager, but the player is limited to drawing only one additional card before the player must stand.

If the player stands and has not busted out (either stands on his or her initial two cards or draws cards but has a point total under 22 and then stands), then the method proceeds to operation 112, which reveals all dealer's cards (e.g., turns the hole-card face up) and which then plays out the dealer's hand according to predetermined rules. In operation 114, if the dealer's total is greater than a predetermined amount (typically 17), then the dealer stands (proceeds to operation 122). If the dealer's total is not greater than the predetermined amount, the method proceeds to operation 116 which deals an additional card to the dealer. If it is then determined 118 that the dealer has not busted (has a point total over 21), the method returns to operation 114. If the dealer has busted, then the player wins the game and the main wager in operation 120 (this assumes the player has not also busted; if the player has already busted then the player would have lost in operation 110).

In operation 122, both the player and the dealer have played out their hand and neither have busted. Thus, their respective point totals (adding the numerical values of each card in the hand) are compared. If the dealer's point total is determined in operation 124 to be lower than the player's point total, then the player wins the game and the main wager in operation 120. Otherwise, if the dealer's point total is determined 128 to be greater than the player's point total, then the player loses the game and the main wager in operation 130. If the player's point total ties the dealer's point total, then that results in a “push” in operation 126 in which the player doesn't win or lose the main wager (the main wager bet is a wash).

If a player is initially dealt two identically ranked cards in operation 102, players can also split in operation 104 by placing an additional split wager equal in value to the main wager, and the player's two initial cards are separated and the dealer deals an additional card on each. The player then plays out each of the two separate hands, each from operation 104. Depending on house rules, players may or may not be allowed to resplit cards.

### SUMMARY OF THE INVENTION

It is an aspect of the present invention to provide an exciting casino game.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the structure and operation of various embodiments of the present invention, will become apparent and more readily appreciated from the following description of the preferred embodiments, taken in conjunction with the accompanying drawings of which:

FIG. 1 is a flowchart illustrating a method of implementing the known game of blackjack;

FIG. 2 is a flowchart illustrating an exemplary method of playing a blackjack game with a reverse dealer total, according to an embodiment;

FIG. 3 is a flowchart illustrating an exemplary method of computing a reverse dealer total, according to an embodiment;

FIG. 4A is a drawing illustrating a gaming table, according to an embodiment;

FIG. 4B is a block diagram illustrating an electronic player tracking system associated with each gaming table, according to an embodiment;

FIG. 5A is a block diagram illustrating exemplary hardware that can be used to implement an electronic version of the methods described herein; and

FIG. 5B is a block diagram illustrating an exemplary network configuration to implement a player playing an online version of the methods described herein.

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method, apparatus, and computer readable storage medium to implement a blackjack

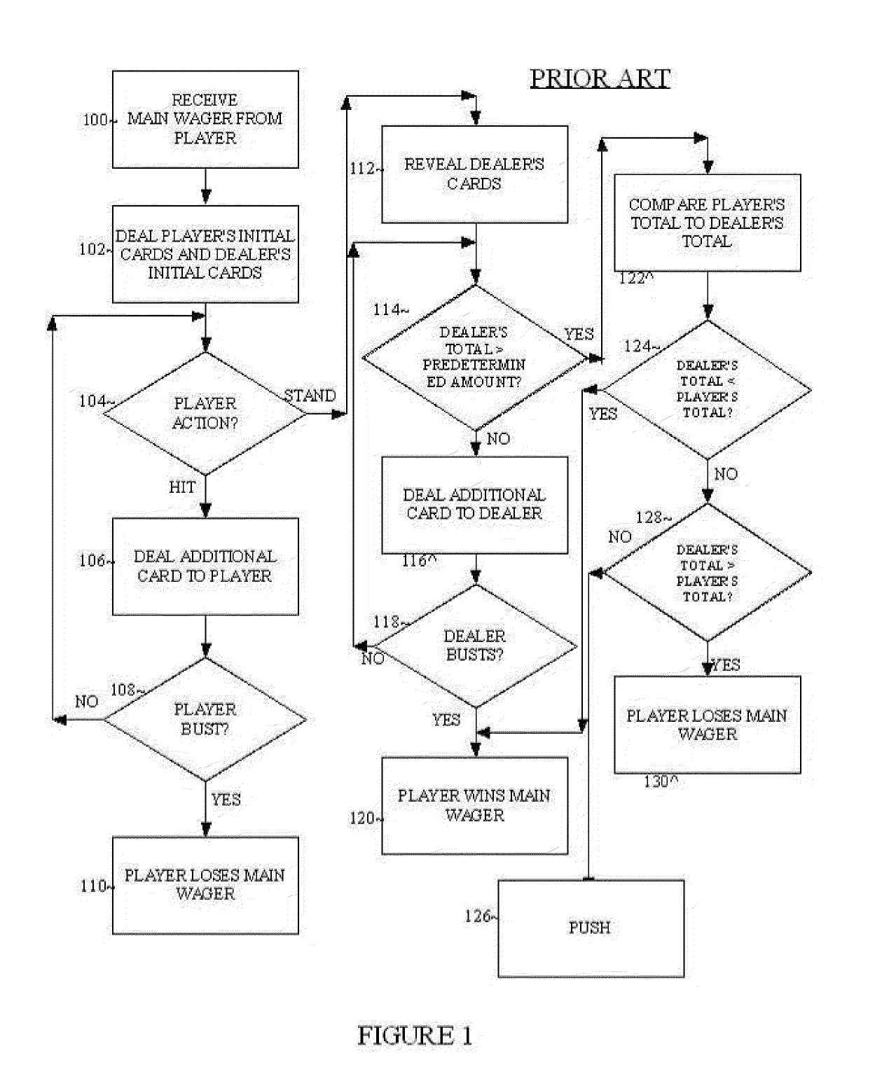

FIG. 1 is a flowchart illustrating a method of implementing the known game of blackjack.

In general, casino blackjack is played by one or more players at a gaming table against a dealer using one or more decks of cards (each deck can be a standard 52 card deck). The idea is for the player to make a point total closest to 21 without going over 21 (busting). Each player (after making a main wager) is dealt two initial cards (typically face up) and the dealer is also dealt two cards (one face up—the upcard, and one face down—the hole card). The player can stand on his or her initial two cards, or continuously hit (take another card) until the player stands or the player's point total is over 21 (upon which the player automatically loses). If the player has not busted, then after the player stands the dealer will play out the dealer's hand according to predetermined rules. One set of dealer predetermined rules is as follows: the dealer will continuously hit until the dealer's point total is greater than 16. Once the dealer has resolved the dealer's hand, the wager is resolved. If the player has busted then the player loses (the main wager). If the player has not busted but the dealer has busted (the dealer's point total is over 21) then the player wins (wins even money on the main wager). If both the player and the dealer have not busted, then if the player's point total is higher than the dealer's point total then the player wins (wins even money on the main wager). If both the player and the dealer have no busted, then if the dealer's point total is higher than the player's point total then the dealer wins (the player loses the main wager). If the player's point total equals the dealer's point total, then the main wager pushes (neither wins nor loses). Other options the player may have at his or her disposal is to double down or split. Cards are given their standard numerical value (i.e., aces count as 1 or 11 (whichever makes the best hand), 2's-10's count as their respective face value, jacks, queens, and kings all count as 10).

An embodiment allows the player to make a first side wager and a second side wager in addition to the main wager associated with the blackjack game. The game gives the player mathematical advantages and in exchange the dealer deals the game with a dealer resolution rule that favors the house more than the standard resolution rule. Upon the dealer busting, some dealer busts will remain dealer busts and some dealer busts will be converted to a point total which serves to help the dealer. When the dealer busts, the dealers cards are evaluated in reverse order from the order they were dealt. If the dealer busts in reverse order, then the dealer still busts. If the reverse point total is in a set of predetermined bust point totals, then the dealer still busts. If the reverse point total is in set of predetermined no-bust point totals, then the dealer's point total (instead of busting) becomes the reverse point total. This will serve to mathematically help the dealer by converting some busts into point totals which may become winning point totals (depending on the player's point total). The game can be played with a standard 52 card deck of cards, or more than one deck.

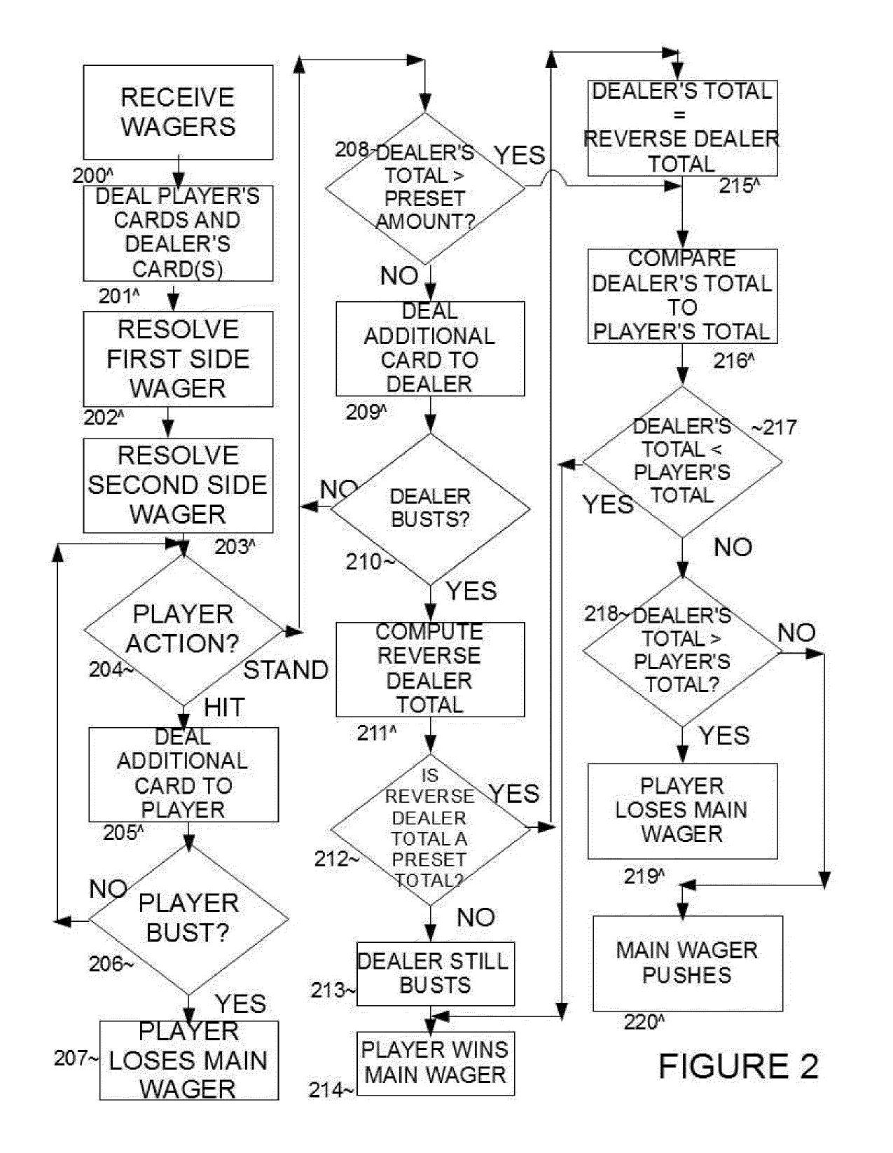

FIG. 2 is a flowchart illustrating an exemplary method of playing a blackjack game with a reverse dealer total, according to an embodiment.

The method can begin with operation 200 which receives wagers from the player. Multiple players can play against the dealer simultaneously at a gaming table and each player is addressed with the same set of rules/procedures. Thus, while “the player” is referred to herein, this can also refer to each player of multiple players playing simultaneously. The player places a main wager in a betting circle for this purpose (the main wager is resolved based on a final winner of the game). The player can also place a mandatory first side wager in a betting circle for this purpose. The player can also place an optional second side wager in a betting circle for this purpose. The first side wager can be mandatory or optional (depending on house rules) and the second side wager can be mandatory or optional (depending on house rules).

From operation 200, the method proceeds to operation 201, which deals the player's two initial cards (typically face up although they can be dealt face down as long as the player can view them) and the dealer's first card(s) which is either one card face up or two cards face up.

From operation 201, the method proceeds to operation 202, which resolves the first side wager (if placed). The first side wager is resolved based upon the player's initial two cards (dealt in operation 201) and the dealer's first card dealt, and applied to a paytable, such as that in Table I. It is noted that any other paytable can be used as well with different winning hands and different payouts, the one in Table I is merely an example. U.S. Pat. No. 7,066,465 (which is incorporated by reference herein in its entirety) describes such a side wager which can be used to resolve the first side wager and the second side wager.

TABLE I

| Hand | Payout |
|---|---|
| Suited 777 | 200:1 |
| Suite 678 | 100:1 |
| Unsuited 777 | 50:1 |
| Unsuited 678 | 30:1 |
| Suited 21 | 15:1 |
| Unsuited 21 | 3:1 |
| Any 20 | 2:1 |
| Any 19 | 2:1 |
| All other | −1 (lose) |

From operation 202, the method proceeds to operation 203, which resolves the second side wager (when placed). If a second dealer's card was not yet dealt (in operation 201) then a second dealer's card is now dealt face up (since a second dealer's card is needed to resolve the second side wager). The second side wager is resolved using the player's initial two cards (dealt in operation 201) and the dealer's second card dealt applied to a paytable such as Table I. In one embodiment, the paytable used for the first side wager and the second side wager is the same, and in another embodiment the paytable used for the first side wager is different from the paytable used for the second side wager.

From operation 203, the method proceeds to operation 204 in which the player takes action to play out his/her hand (e.g., hit, stand, double, split). Note that both dealer's cards (the dealer only has two cards at this point) are face up so the player has the advantage of knowing what the dealer's initial two cards are when the player decides what action to take. Operations 204, 205, 206, 207 can be implemented the same as operations 104, 106, 108, 110 from FIG. 1. Note that the first time operation 204 is performed in a game for a player the player can double (by placing a double wager up the amount of the main wager) and the player would hit (proceed to operation 205) but (in one embodiment) the player would not be able to hit any further cards (if the player busted the method would proceed to operation 207 and if the player did not bust the method would proceed to operation 208). Thus, the player can double any two card hand but not any hand with more than two cards, while in another embodiment the player can double a hand regardless of how many cards the player has. The player can also split in operation 204 (when the player has received two initial cards of the same point value) whereby the player can place a split wager equal to the main wager and the player would “split” the two initial cards and play out a separate hand on each. The first side wager and the second side wager are resolved using the player's two initial cards and so whether the player splits or not would not matter to the resolution of these wagers.

Note that in one embodiment, any player total of 21 (even after doubling) using three or more cards wins immediately and is paid at even money. This is different than a player blackjack which is a total of 21 using only two cards (which can pay 3:2 or 1:1 depending on the house rules). In an embodiment, a two card dealer total of 21 counts as 21, not blackjack. This means that a player blackjack (two card 21) will always beat a dealer two card 21, and a player total of 21 (with more than two cards) will tie a dealer's total of 21 (regardless of how many cards are in the dealer's hand).

If the player stands in operation 204 then the method proceeds to operation 208. Operations 208, 209, 210 can be performed the same as operations 114, 116, 118 in FIG. 1. In operation 208, it is determined whether the dealer's total is greater than a preset (predetermined) amount based on house rules (e.g., a soft 17, hard 18, hard 17, etc.) The present amount can also be a combination of soft/hard totals such as soft 17 and hard 16 (in other words, the dealer would always hit up to hard 16 and stay on hard 17 and higher but would always hit up to soft 17 and stay on soft 18 and higher). If the dealer's total is greater than the preset amount then the method proceeds to operation 215.

If in operation 208 the dealer's total (the point total sum of all point values of cards in the dealer's hand) is not greater than the preset amount then the method proceeds to operation 209 which deals an additional card to the dealer.

From operation 209, the method proceeds to operation 210 which determines whether the dealer's hand busts (has a point total over 21 with all aces counting as 1). If not, the method returns to operation 208.

If in operation 210, it is determined that the dealer's hand busted, then the method proceeds to operation 211 which computes a reverse dealer total. The reverse dealer total is computing by a) ordering the cards in the reverse order that they were dealt to the dealer; and b) starting with the first card in the reverse order (the last card dealt to the dealer), operations 208, 209 and 210 are performed again using each next card in the reverse order. In other words, it is as if the dealer's hand is now being redealed but in the reverse order it was dealt originally. For example, A) the first two cards in the reverse order are added to create the reverse dealer total. B) if the reverse dealer total is not greater than the present amount, then C) the next card in the reverse order is added to the reverse dealer total. D) If the reverse dealer total has not busted then return to step B. For example (assuming the preset amount is 16), if the dealer busts with 3-8-3-9 (suits do not matter) then the reverse dealer total is a 20 (because the dealer starts with 9-3, adds 8 and then stops since it is over 16). As another example, if the dealer busts with 8-3-5-9 then the reverse dealer total is a 17 (because the dealer starts with 9-5 then hits a 3 and then stops since 17>16). As a further example, if the dealer busts with 9-6-8 then the reverse dealer total is also a bust (because the dealer starts with 8-6 and then hits 9 for a total of 23 which is over 21 which is a bust).

Once the reverse dealer total is determined in operation 211, then the method proceeds to operation 212, which determines if the reverse dealer total is a preset total. There can be a predetermined set of one or more preset totals, and if the reverse dealer total is in this set then the reverse dealer total is a preset total and if the reverse dealer total is not in this set then the reverse dealer total is not a preset total. For example, the set of preset totals can include only 20 and 21, e.g., if the reverse dealer total is 20 or 21 then it is a preset total otherwise it is not a preset total. Other sets of preset totals can be used as well, such as 17, 18, 19, 20, 21, 17 and 18, 18 and 19, 19 and 20, 20 and 21, 17 and 21, 17 and 18 and 19, and any combination of any number of point totals from 17 to 21. These sets consist only of their numbers (no other ones are part of the set).

If in operation 212 it is determined that the reverse dealer total is not a preset total (e.g., not in the set of preset totals) then the method proceeds to operation 213 wherein the dealer still busts and thus the player wins the main wager, typically even money (e.g., 1:1).

If in operation 212, it is determined that the reverse dealer total is a preset total then the method proceeds to operation 215 in which the dealer's total equals the reverse dealer total. In other words, the reverse dealer total is used for the dealer's total (instead of the dealer's total being a bust) so that in effect the dealer has no longer busted and the reverse dealer total is used in a comparison to the player's total (in operations 216-218).

From operation 215, the method proceeds to operation 216, which compares the dealer's total to the player's total (the sum of point values of all cards in the player's hand).

From operation 216, the method proceeds to operation 217, wherein if the dealer's total is less than the player's total then the method proceeds to operation 214 wherein the player wins the main wager (typically paid even money).

If in operation 217, it is determined that the dealer's total is not less than the player's total, then the method proceeds to operation 218 which determines whether the dealer's total is greater than the player's total (but note that the dealer has not busted because if the dealer busted then the method would be at operation 213-214). If it is determined that the dealer's total is greater than the player's total then the method proceeds to operation 219 in which the player loses the main wager.

If in operation 218 it is determined that the dealer's total is not greater than the player's total then the method proceeds to operation 220 wherein the main wager pushes (neither wins nor loses).

Any rule variations can be applied to the game. For example, in one embodiment, the following rules can be used: players may double on any two card hand, even after splitting; player's may split any pair expect aces three times, to a total of four cards; player's may split aces only once and will receive only one card per hand.

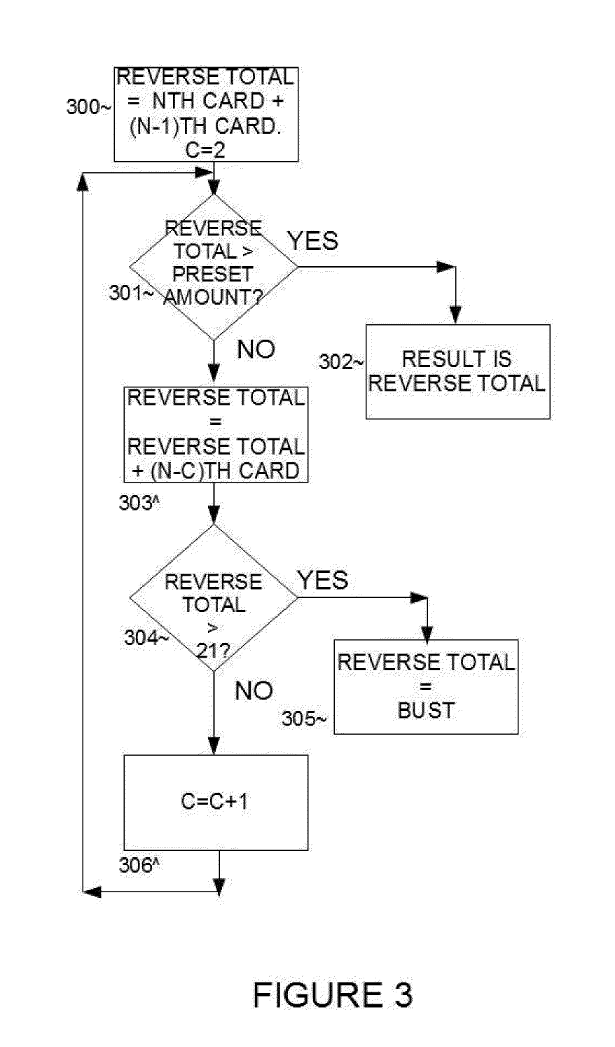

FIG. 3 is a flowchart illustrating an exemplary method of computing a reverse dealer total, according to an embodiment. The reverse dealer total (as stated herein) is a dealer total computed from the same dealer's cards but as if they were dealt in the reverse order. In some cases both totals (the original dealer total and the reverse dealer total) will be the same but in some cases they will be different. Consider that the dealer's hand has N cards in it and they are numbered from 1 . . . N in the order they were dealt to the dealer. Thus, N is the last card dealt to the dealer (which would be the card that caused the dealer to bust), 1 is the first card dealt to the dealer, 2 is the second card dealt to the dealer, etc.

The method can begin with operation 300, which computes a reverse total equals the Nth card plus the (N−1)th card. In other words, if there were 5 cards dealt to the dealer then the reverse total equals the 5^{th} card plus the 4^{th} card. A counter C is set equal to 2 which is used to count down cards.

From operation 300, the method proceeds to operation 301 which determines if the reverse total is greater than a preset amount. For example, if house rules dictate that the dealer stands on all hands greater than 16 and hits on all hands less than or equal to the 16 than the preset amount is 16. If in operation 301 it is determined that the reverse total is greater than the preset amount, then the method proceeds to operation 302 in which the result is the reverse total. Thus, instead of the original dealer total (which would typically be a bust), the new dealer total is now the reverse total (which is not a bust here).

If in operation 301 it is determined that the reverse total is not greater than the preset amount, then the method proceeds to operation 303 which adds the (N−C)th card to the reverse total.

From operation 303, the method proceeds to operation 304, which determines if the reverse total is greater than 21 (in other words if the reverse total is a bust). If so, then the method proceeds to operation 305 which results in the reverse total being a bust (same as the original dealer total).

If in operation 304, the reverse total is not greater than 21 (the reverse total/dealer has not busted) then the method proceeds to operation 306 which increments C by 1. The method then returns to operation 301. This causes a loop to continue until the reverse dealer total busts or has a hand that is greater than the preset amount.

Since the reverse dealer total is used when the dealer original busts, this gives the dealer an opportunity to make a hand when the dealer would have busted. Since this rule hurts the player, in order to compensate to the player for this disadvantage, the player is allowed to see the dealer's initial two cards before the player takes any action regarding his/her hand (e.g., hit, stand, double, split).

As an example of computing a reverse dealer total, consider the dealer is dealt the following cards (in order of first dealt to last dealt): 4, A, 10, A, 7. This is a total of 23 (bust). Now, dealing the same cards all over again in reverse order: 7, A, 10, A, 4 results in a dealer total of 18 (all that is needed is the first two cards, the remaining cards are not needed and not used). As another example of a reverse total, consider the dealer is dealt the following cards: 5, 2, 4, 5, 5 (total of 21, in this example the dealer did not bust unlike the game rules). In reverse, the total would still be 21. As a further example, consider the dealer is dealt the following cards: A, 5, 10, 6 (total of 22 which is a bust since it is over 21). The reverse total would be 6+10+5 equals 21 (the ace is not used since 21 is over the preset amount).

An example of the entire game will now be presented. Oscar places (operation 200) a $1 main wager, a $1 first side wager, and a $1 second side wager. The dealer deals (operation 201) Oscar a 4-spades/7-spades and the dealer deals himself (the dealer's hand) a 10-spades/5-clubs (both dealer's initial cards dealt face up). The player's first side wager is resolved (operation 202) using the hand 4-spades/7-spades/10-spades (the player's initial two cards and the dealer's first card dealt) which is a hand of a suited 21, from Table I pays 15:1 ($15). The player's second side wager is resolved (operation 203) using the hand 4-spades/7-spades/5-clubs which is not a winning hand on Table I so the player's second side wager loses (is taken by the house/dealer). The player now has to resolve (play) the player's hand (operation 204) and decides to double and places a $1 double wager alongside the $1 main wager. The dealer deals (operation 205) the player a 5-hearts as the double card (the player cannot hit again since the player doubled). The player now has a point total of 16. The dealer's hand is now resolved (starting at operation 208) and since the dealer's total is 15 the dealer's total is not greater than the preset amount (16) and so the dealer hits (gets an additional card in operation 209). The dealer's hit card is an Ace-clubs which gives the dealer a total (everywhere total is used is synonymous with “point total” and vice-versa) of 16. Since this is still under the preset amount, the dealer hits again and receives a 7-spades for a total of 23 (bust since it is over 21). Since the dealer busted (operation 210) a reverse dealer total is computed (operation 211). The reverse dealer total is computed to be 18 (7-spades plus the ace-clubs). Since 18 is not (operation 212) in the set of preset totals (20 and 21) then the reverse dealer total is not used (e.g., the reverse dealer total is still a bust) and the dealer still busts (operation 213) which means the player wins the main wager and the double wager (wins $2). If the reverse dealer total was 20 or 21, then the reverse dealer total (18) would be used as the dealer's point total and since this would beat the player's total (15) then the player would lose the main wager and the double wager (total of $2). The resolution of the main wager and any double wagers, split wagers, etc., would have no effect on the first side wager and the second side wager.

The game examples described above can also be played in their entirety using an electronic device (as described below) wherein the card values are electronically displayed on the output device and decisions by the player are inputted into the electronic device by the player using the input device. Programming for the game implements a virtual deck which uses a random number generator to virtually shuffle the virtual deck so that in effect, random cards can be dealt from the deck.

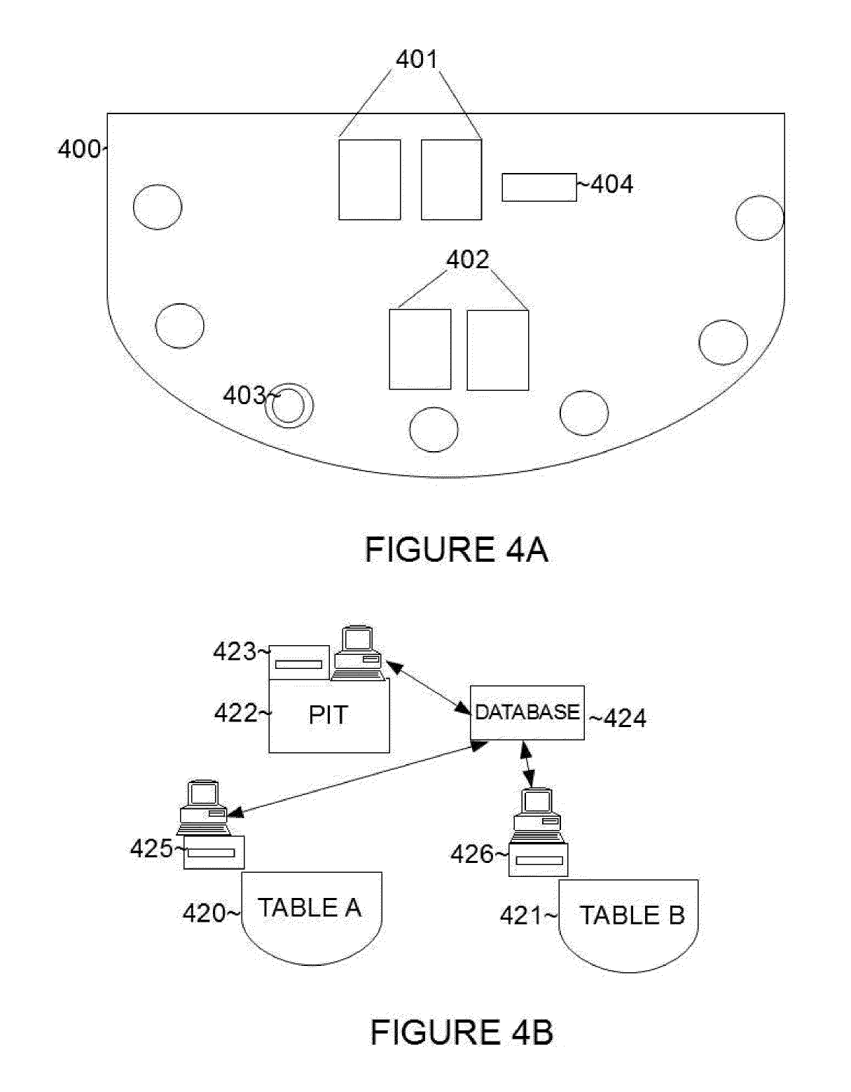

FIG. 4A is a drawing illustrating a gaming table, according to an embodiment.

A physical gaming table 400 (typically made of wood with felt on top with the layout imprinted on it) is used to play the game in a physical real world casino. One example of a table that can be used in a physical casino is illustrated in U.S. Design patent D263,975 which is incorporated by reference herein in its entirety. The layout on top of the felt has imprinted on it seven betting circles as illustrated in FIG. 4A, each betting circle is where the respective player can place their chips (wager). The felt can be green and the imprinted betting circles can be white, although of course any color scheme can be used. Such a table can accommodate any number of players (such as seven as illustrated) or any other number (e.g. 2-10). All players play simultaneously against the dealer as known in the art. A player's hand 402 and a dealer's hand 401 are shown. A player's wager 403 is shown in the form of a chip or chips and is placed inside the player's betting circle. The dealer's area can also accommodate a physical card reader 404 for reading the dealer's hole card as described in U.S. Pat. No. 5,681,039, which is incorporated by reference in its entirety for all purposes. The physical card reader can be an electronic card reader which electronically scans a face down card and lights up a particular light (e.g., LED, etc.) if the face down card is a 10 or ace (which would give the dealer blackjack when the dealer's up-card is an ace or 10 respectively) otherwise a different light (e.g., a “green light”) lights up telling the dealer that the hole-card does not give the dealer blackjack and thus the dealer can continue dealing.

While not shown, the game can also be offered with any type of additional side wager in order to generate more action for the casino and more excitement for the players. Also not pictured in FIG. 4A is an electronic mechanical shuffler such as that described in U.S. Pat. No. 8,025,294 which is incorporated by reference here in its entirety which can optionally be used by the dealer to shuffle the deck or decks of cards. Also not pictured in FIG. 4A is an optional shoe which the cards can be placed into and dealt out of by the dealer, such as the shoe described in U.S. Pat. No. 4,457,512 which is incorporated by reference herein in its entirety.

FIG. 4B is a block diagram illustrating an electronic player tracking system associated with each gaming table, according to an embodiment.

When players play casino table games the casino can typically track the player so that the casino knows how much gaming action a player is giving the casino and hence how much to reward each player with complimentaries (free or discounted rooms, food, etc.) Such a system is described in U.S. Pat. No. 5,836,817, which is incorporated by reference herein in its entirety for all purposes. Each player can have their own players card which is a plastic card that has their name imprinted on it and computer readable indicia (e.g., a magnetic stripe) which stores an identification number of the player's card (and hence the identification number of the player who owns the card). The player's card can be swiped through an electronic card readers 323, 325, 326 which can be electronic read and the data therein transmitted to the associated computer.

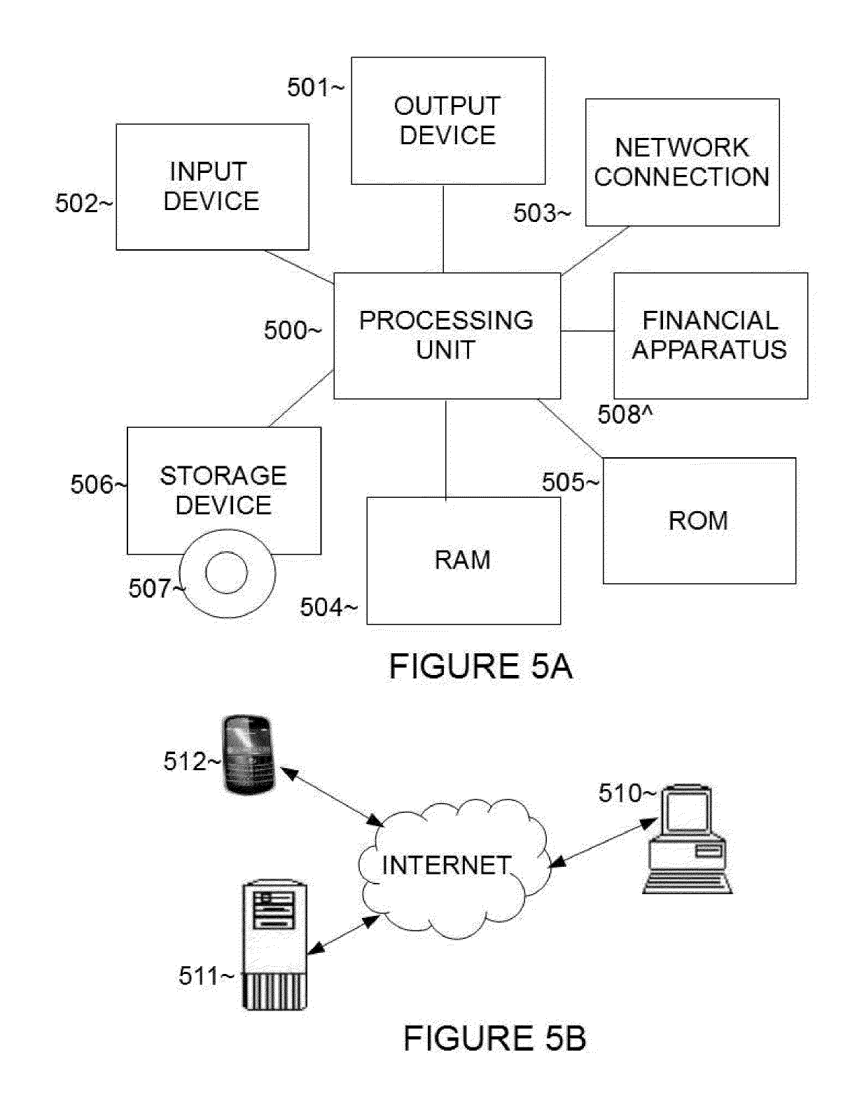

A gaming table A 420 (which can be used to play any method described herein) and a gaming table B 421 (which can be used to play any method described herein) can be associated with a pit 422 (which has its own computer) which has a card reader 423 to read the electronically encoded information on a player's card (the card reader can also be located at the tables themselves) and transmit the information to an associated computer which can communicate information contained on the player's card (e.g., an identification number of the player associated with the card) to the electronic database 424 along with play data relating to the player who owns the player's card. Table A 420 has its own card reader 425 and associated computer (the one next to card reader 425 which receives information from the card reader 425) and table B 421 also has its own card reader 326 and associated computer (the one next to card reader 326 which receives information from the card reader 326). The computers at table A 320 and table B 321 are connected to the electronic database 324. Casino employees can enter data regarding each player's play (for those players that present a players card) into a computer at the table or at the pit which transmits the play data (e.g., average wager amount, time of play, etc.) to the electronic casino database 524 that stores playing history information for players at the casino. The computers illustrated in FIG. 4B can all have the structure as illustrated in FIG. 5A.

FIG. 5A is a block diagram illustrating hardware that can be used to implement electronic versions of all of the wagering methods/features described herein, according to an embodiment. The hardware can be, for example, an electronic gaming machine (EGM) used in casinos. The hardware can also be a personal computer, playing the game using the Internet at an Internet casino for real money. The hardware can also be a digital casino table, for example the kind described in U.S. Pat. No. 7,775,887, which is incorporated by reference herein in its entirety. The hardware can also be any computing device, such as a cellular phone, tablet, etc., and all methods/features described herein can be installed as software (e.g., an app) on the device. The hardware can also be any other type of device, working individually or in conjunction with other devices. The hardware can also be a digital poker table, of the kind described in U.S. Pat. No. 7,758,411 which is incorporated by reference herein in its entirety.

A processing unit 500 (such as a microprocessor and any associated components) is connected to an output device 501 (such as an LCD monitor, touch screen, CRT, etc.) which is used to display to the player any aspect of the method (e.g., cards dealt, etc.), and an input device 502 (e.g., buttons, a touch screen, a keyboard, mouse, etc.) which can be used to input from the player any decision/action made by the player (e.g., how much to bet, how to play a hand, etc.). Any and all methods/features/embodiments described herein can be performed by the processing unit 500 by loading and executing respective instructions which are programmed to perform all methods/features/embodiments. The processing unit 500 can also be connected to a network connection 503, which can connect the electronic gaming device to a computer communications network such as the Internet, a LAN, WAN, etc. The processing unit 400 is also connected to a RAM 504 and a ROM 505. The processing unit 400 is also connected to a storage device 506 which can be a DVD-drive, CD-ROM, flash memory, etc. Multiple such processing units can also work in collaboration with each other (in a same or different physical location). A non-transitory computer readable storage medium 507 can store a program which can control the electronic device (via the processing unit) to perform any and all of the methods described herein and can be read by the storage device 506. The processing unit 500 can also be connected to a financial apparatus 508 which can receive cash and convert the received cash into playable credits for use by the player when playing the electronic device. When the player decides to cash out any remaining credits, the financial apparatus 508 can issue coins or a cashless ticket (voucher) for the remaining credits which is redeemable by the player.

While one processing unit is shown, it can be appreciated that one or more such processor can work together (either in a same physical location or in different locations) to combine to implement any of the methods described herein. Programs and/or data required to implement any and all of the methods/features described herein can all be stored on any non-transitory computer readable storage medium (volatile or non-volatile, such as CD-ROM, RAM, ROM, EPROM, microprocessor cache, etc.)

FIG. 5B is a block diagram illustrating an exemplary network configuration to implement a player playing an online version of the methods described herein. All the methods described herein can be implemented on an online casino for real money (credits which are purchased for cash and are redeemable for cash) or for non-cash value credits. A player uses a personal computer 510 (e.g., cell phone, tablet, PC, etc.) can connect to a server 511 (which can have the structure illustrated in FIG. 5A) using a computer communications network such as the Internet. The server 511 hosts an online casino which determines the outcomes of the game and serves the outcomes to the computer 510 so the computer 510 displays the outcomes to the player. Other users can also play at the online casino hosted by the server 511 simultaneously, such as using a cell phone 512 with wireless internet connectivity. Any number of players connected to the internet can play contemporaneously at the sever 511. The general structure of online casinos is well known in the art.

It is noted that the methods described herein can be played with any number of standard decks of 52 cards (e.g., 1 deck to 10 decks). A standard deck is a collection of cards comprising an Ace, two, three, four, five, six, seven, eight, nine, ten, jack, queen, king, for each of four suits (comprising spades, diamonds, clubs, hearts) totaling 52 cards. Cards can be shuffled or a continuous shuffling machine (CSM) can be used. A standard deck of 52 cards can be used, as well as other kinds of decks, such as Spanish decks, decks with wild cards, etc. The operations described herein can be performed in any sensible order. Furthermore, numerous different variants of house rules can be applied.

Note that in the embodiments played using computers (a processor/processing unit), “virtual deck(s)” of cards are used instead of physical decks. A virtual deck is an electronic data structure used to represent a physical deck of cards which uses electronic representations for each respective card in the deck. A virtual card is displayed on an electronic output device using computer graphics and is displayed to mimic a real life image of that card.

Methods described herein can also be played on a physical table using physical cards and physical chips used to place wagers. Such physical chips can be directly redeemable for cash. When a player wins (dealer loses) the player's wager, the dealer will pay that player a respective payout amount. When a player loses (dealer wins) the player's wager, the dealer will take (collect) that wager from the player and typically place those chips in the dealer's chip rack. All rules, embodiments, features, etc. of a game being played are typically communicated to the player (e.g., verbally or on a written rule card) before the game begins.

Initial cash deposits can be made into the electronic gaming machine which converts cash into electronic credits. Wagers can be placed in the form of electronic credits, which can be cashed out for real coins or a ticket (e.g., ticket-in-ticket-out) which can be redeemed at a casino cashier or kiosk for real cash and/or coins.

Any description of a component or embodiment herein also includes hardware, software, and configurations which already exist in the prior art and may be necessary to the operation of such component(s) or embodiment(s).

Further, the operations described herein can be performed in any sensible order. Any operations not required for proper operation can be optional. Further, all methods described herein can also be stored on a computer readable storage to control a computer. All variations and features described herein can be combined with any other features described herein without limitation.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A method for implementing a game, the method comprising:
providing an input device, an output device, and an electronic processing unit connected to the input device and the output device;
executing, on the processing unit, instructions that perform:
providing dealer bust resolution rules comprising a) determining a reverse dealer total; b) upon the reverse dealer total being in a set of preset totals then the dealer's total becomes the reverse dealer total;
receiving a main wager from a player;
dealing a player's hand and a dealer's hand;
enabling the player to complete the player's hand and determining a player's total;
enabling the dealer to complete the dealer's hand and determining a dealer's total, wherein if the dealer busts then executing the dealer bust resolution rules; and
resolving the main wager.

2. The method as recited in claim 1, wherein the main wager is resolved based on a comparison between the player's total and the dealer's total.

3. The method as recited in claim 1, wherein the reverse dealer total is computed by adding the last two cards dealt to the dealer into a reverse dealer total, and a) if the reverse dealer total is not greater than a preset amount then adding a dealer's card dealt immediately prior to the last card used to the reverse dealer total, b) if the reverse dealer total is greater than 21 then the reverse dealer total is a bust otherwise return to step a).

4. The method as recited in claim 1, further comprising along with the main wager receiving a first side wager.

5. The method as recited in claim 4, wherein the first side wager is resolved based upon the player's initial two cards and the dealer's first card dealt.

6. The method as recited in claim 5, further comprising along with the main wager receiving a second side wager.

7. The method as recited in claim 6, wherein the second side wager is resolved based upon the player's initial two cards and the dealer's second card dealt.

8. The method as recited in claim 1, wherein the first two cards in the dealer's hand are dealt face up before the enabling the player to complete the player's hand.

9. The method as recited in claim 1, wherein the set of preset totals includes only 20 and 21.

10. A method for implementing a game, the method comprising:
providing at least one physical deck(s) of cards and a physical gaming table;
providing dealer bust resolution rules comprising a) determining a reverse dealer total; b) upon the reverse dealer total being in a set of preset totals then the dealer's total becomes the reverse dealer total;
receiving a main wager from a player on the physical gaming table;
dealing, from the at least one physical deck(s) of cards, a player's hand and a dealer's hand;
enabling the player to complete the player's hand and determining a player's total;
enabling the dealer to complete the dealer's hand and determining a dealer's total, wherein if the dealer busts then executing the dealer bust resolution rules; and
resolving the main wager.

11. An apparatus to implementing a game, the apparatus comprising:
an input device;
an output device;
an electronic processing unit connected to the input device and the output device, the electronic processing unit configured to:
provide dealer bust resolution rules comprising a) determining a reverse dealer total; b) upon the reverse dealer total being in a set of preset totals then the dealer's total becomes the reverse dealer total;
receive a main wager from a player;
deal a player's hand and a dealer's hand;
enable the player to complete the player's hand and determining a player's total;
enable the dealer to complete the dealer's hand and determining a dealer's total, wherein if the dealer busts then executing the dealer bust resolution rules; and
resolve the main wager.

12. The apparatus as recited in claim 11, wherein the processing unit is further configured such that the main wager is resolved based on a comparison between the player's total and the dealer's total.

13. The apparatus as recited in claim 11, wherein the processing unit is further configured such that the reverse dealer total is computed by adding the last two cards dealt to the dealer into a reverse dealer total, and a) if the reverse dealer total is not greater than a preset amount then adding a dealer's card dealt immediately prior to the last card used to the reverse dealer total, b) if the reverse dealer total is greater than 21 then the reverse dealer total is a bust otherwise return to step a).

14. The apparatus as recited in claim 11, wherein the processing is further configured to receive a first wager along with the main wager.

15. The apparatus as recited in claim 14, wherein the processing unit is further configured such that the first side wager is resolved based upon the player's initial two cards and the dealer's first card dealt.

16. The apparatus as recited in claim 15, wherein the processing unit is further configured such that a second side wager is received along with the main wager.

17. The apparatus as recited in claim 16, wherein the processing unit is further configured such that the second side wager is resolved based upon the player's initial two cards and the dealer's second card dealt.

18. The apparatus as recited in claim 11, wherein the processing unit is further configured such that the first two cards in the dealer's hand are dealt face up before the enabling the player to complete the player's hand

19. The apparatus as recited in claim 11, wherein the processing unit is further configured such that the set of preset totals includes only 20 and 21.
